(19) United States
(12) Patent Application Publication
(10) Pub. No.: US 2023/0419561 A1
(43) Pub. Date: Dec. 28, 2023

(54) THREE-DIMENSIONAL MODEL RENDERING METHOD AND APPARATUS, DEVICE, STORAGE MEDIUM, AND PROGRAM PRODUCT

(71) Applicant: Tencent Technology (Shenzhen) Company Limited, Shenzhen (CN)

(72) Inventors: Fei LING, Shenzhen (CN); Fei XIA, Shenzhen (CN); Yongxiang ZHANG, Shenzhen (CN); Jun DENG, Shenzhen (CN)

(21) Appl. No.: 18/243,027

(22) Filed: Sep. 6, 2023

Related U.S. Application Data
(63) Continuation of application No. PCT/CN2022/137127, filed on Dec. 7, 2022.

(30) Foreign Application Priority Data
Mar. 23, 2022 (CN) 202210291953.2

(51) Int. Cl. G06T 11/00; G06T 17/20

(52) U.S. Cl. CPC G06T 11/001; G06T 17/20

(57) ABSTRACT

A three-dimensional model rendering method performed by a computer device is disclosed. The method includes: acquiring material information of a plurality of triangle primitives in a three-dimensional model, at least two triangle primitives in the plurality of triangle primitives having different material information; generating model parameters of the three-dimensional model based on the material information of the triangle primitives; and rendering a two-dimensional image of the three-dimensional model based on the rendering parameters of the rasters.

### CROSS-REFERENCE TO RELATED APPLICATIONS

This application is a continuation application of PCT Patent Application No. PCT/CN2022/137127, entitled “THREE-DIMENSIONAL MODEL RENDERING METHOD AND APPARATUS, DEVICE, STORAGE MEDIUM, AND PROGRAM PRODUCT” filed on Dec. 7, 2022, which is based on and claims priority to Chinese Patent Application No. 202210291953.2, entitled “THREE-DIMENSIONAL MODEL RENDERING METHOD AND APPARATUS, DEVICE, STORAGE MEDIUM, AND PROGRAM PRODUCT” filed on Mar. 23, 2022, all of which is incorporated by reference in its entirety.

### FIELD OF THE TECHNOLOGY

This application relates to the field of artificial intelligence technologies, and in particular, to a three-dimensional model rendering method and apparatus, a device, a storage medium, and a program product.

### BACKGROUND OF THE DISCLOSURE

In the related technology, a three-dimensional model may be rendered into a two-dimensional image by pipeline rendering. In practice, a three-dimensional model includes sub-model of different materials, model rendering is performed in units of sub-models, the sub-models are rendered by using different rendering pipelines, and rendering results of the sub-models are spliced into a two-dimensional image corresponding to the three-dimensional model.

However, in the foregoing related technology, one-time pipeline rendering can only be used for rendering a sub-model of a single material. In a case of a three-dimensional model including sub-models of different materials, rendering of the three-dimensional model is completed by multiple times of pipeline rendering, resulting in low efficiency of rendering a three-dimensional model into a two-dimensional image.

### SUMMARY

Embodiments of this application provide a three-dimensional model rendering method and apparatus, a computer device, a storage medium, and a computer program product, which can improve the rendering efficiency of a three-dimensional model.

An embodiment of this application provides a three-dimensional model rendering method performed by a computer device, which includes:
acquiring material information of a plurality of triangle primitives in a three-dimensional model, at least two triangle primitives in the plurality of triangle primitives having different material information;
generating model parameters of the three-dimensional model based on the material information of the triangle primitives, the model parameters including rendering parameters of rasters in the three-dimensional model; and
rendering a two-dimensional image of the three-dimensional model based on the rendering parameters of the rasters.

An embodiment of this application provides a computer device, which includes a processor and a memory. The memory stores at least one instruction that, when loaded and executed by the processor, causes the computer device to implement the foregoing three-dimensional model rendering method.

An embodiment of this application provides a non-transitory computer-readable storage medium, which stores at least one instruction that, when loaded and executed by a processor of a computer device, causes the computer device to implement the foregoing three-dimensional model rendering method.

The technical solutions provided in the embodiments of this application may achieve the following beneficial effects:

During rendering, a three-dimensional model is rendered in basic units of rasters based on rendering parameters of the rasters. The rendering parameters of the rasters are generated based on different material information, that is, effects of triangle primitives of different materials in the three-dimensional model on rendering results are fused, so that the accuracy and effect of a two-dimensional image obtained by rendering are high. Furthermore, the material information is used as a partial basis for generating the rendering parameters, so that parts of different materials in the three-dimensional model can be rendered at one time, and the efficiency of rendering the three-dimensional model into the two-dimensional image is improved.

### BRIEF DESCRIPTION OF THE DRAWINGS

FIG. 1 is a schematic diagram of a three-dimensional model rendering system according to an embodiment of this application.

FIG. 2 is a schematic diagram of a three-dimensional model rendering system according to an embodiment of this application.

FIG. 3 is a flowchart of a three-dimensional model rendering method according to an embodiment of this application.

FIG. 4 is a schematic diagram of a texture sampling method according to an embodiment of this application.

FIG. 5 is a flowchart of a three-dimensional model rendering method according to an embodiment of this application.

FIG. 6 is a schematic diagram of an iterative training effect of a rendering model according to an embodiment of this application.

FIG. 7 is a block diagram of a three-dimensional model rendering apparatus according to an embodiment of this application.

FIG. 8 is a structural block diagram of a computer device according to an embodiment of this application.

### DESCRIPTION OF EMBODIMENTS

In order to make the objectives, technical solutions, and advantages of this application clearer, the following describes implementations of this application in detail with reference to the accompanying drawings.

In the following description, the term “some embodiments” describes subsets of all possible embodiments. It may be understood that the term “some embodiments” may be the same subset or different subsets of all the possible embodiments, and can be combined with each other without conflict.

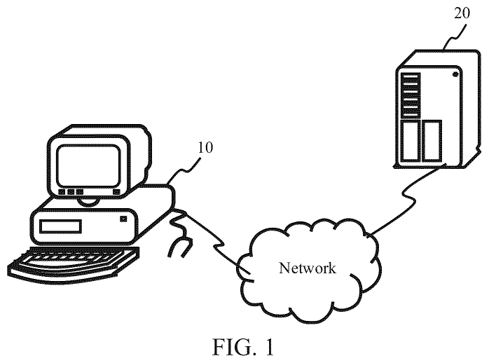

FIG. 1 is a schematic diagram of a model rendering system according to an embodiment of this application. The model rendering system may include: a terminal 10 and a server 20. The terminal 10 and the server 20 perform data transmission through a network. The network may be a wide area network, a local area network, or a combination of a wide area network and a local area network.

The terminal 10 may be, for example, an electronic device such as a mobile phone, a tablet computer, a game console, an eBook reader, a multimedia playback device, a wearable device, a personal computer (PC), a smart voice interaction device, a smart home appliance, a vehicle-mounted terminal or a flight vehicle. This is not defined in this embodiment of this application. In practice, the terminal 10 includes a client of an application program. The application program may be any application program with a model rendering function, such as a modeling application program, a game application program or a video application program. In practice, the foregoing application program may be an application program that needs to be downloaded and installed, or may be a click-to-run application program. This is not defined in this embodiment of this application.

The server 20 is configured to provide backend services for the terminal 10. The server 20 may be a server, a server cluster composed of a plurality of servers, or a cloud computing service center. In practice, the server 20 may be a backend server of the client of the foregoing application program. In some embodiments, the server 20 provides backend services for a plurality of terminals 10.

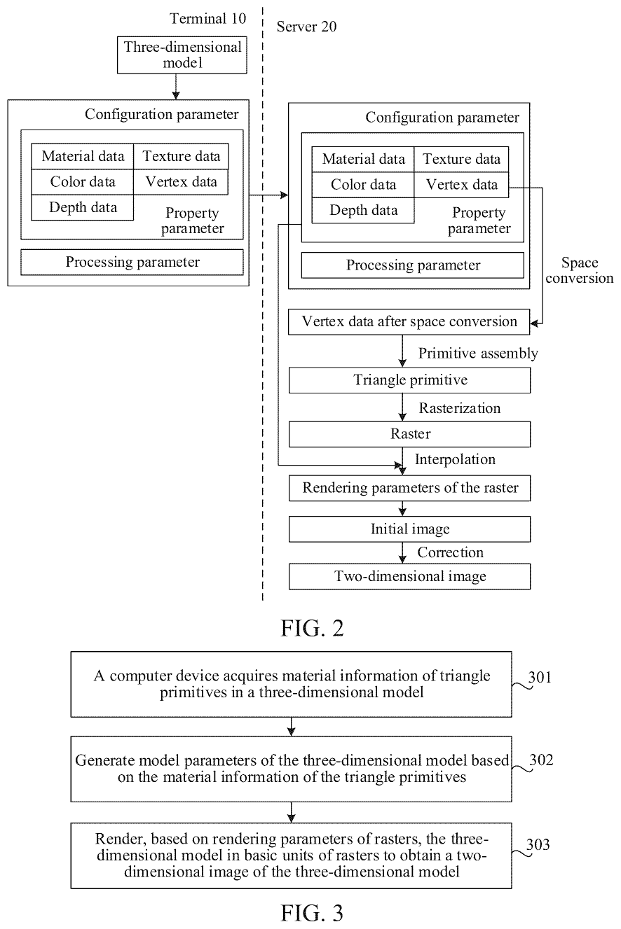

In this embodiment of this application, the foregoing server 20 is configured to render a three-dimensional model provided by the terminal 10 to generate a two-dimensional image. Exemplarily, as shown in FIG. 2, a user constructs a three-dimensional model by using the terminal 10, and configures corresponding configuration parameters for the three-dimensional model. The configuration parameters include property parameters and processing parameters of the three-dimensional model. The property parameters indicate properties of the three-dimensional model, such as material data, color data, depth data, texture data, and vertex data. The processing parameters indicate a processing method for the three-dimensional model during rendering, such as configuration data of a shader used during rendering. Next, after acquiring the foregoing three-dimensional model and the configuration parameters of the three-dimensional model, the server 20 renders the three-dimensional model based on the configuration parameters.

As shown in FIG. 2, the server 20 performs space conversion on the vertex data in the configuration parameters to convert the vertex data from a model space to a world space and then convert from the world space to a clip space, and then performs primitive assembly and rasterization on the vertex data subjected to space conversion to obtain triangle primitives of the three-dimensional model and a plurality of rasters included in the triangle primitive. Next, the server 20 performs interpolation on each raster to insert a material parameter and the configuration parameters (material index tensor) into the rasters and insert the color data, the depth data, and the texture data into the rasters, to generate rendering parameters of the rasters. The server 20 renders, based on the rendering parameters of the rasters, the three-dimensional model in basic units of rasters to generate an initial image of the three-dimensional model, and corrects the initial image to generate a two-dimensional image of the three-dimensional model. The correction may be tone mapping, gamma correction, anti-aliasing correction or the like. In practice, after acquiring the foregoing two-dimensional image, the terminal 10 displays the two-dimensional image to the user.

The foregoing description of FIG. 2 is merely exemplary and interpretative. In an exemplary embodiment, functions of the terminal 10 and the server 20 may be flexibly set and adjusted. This is not defined in this embodiment of this application. Exemplarily, the terminal 10 performs image rendering according to the process described in FIG. 2, and the server 20 provides a data storage service for the terminal 10 only.

FIG. 3 is a flowchart of a three-dimensional model rendering method according to an embodiment of this application. The method may be applied to the server 20 and/or the terminal 10 in the model rendering system shown in FIG. 1. The server 20 and the terminal 10 are hereinafter collectively referred to as a “computer device”. The method may include at least one of the following steps (301 to 303).

Step 301: A computer device acquires material information of triangle primitives in a three-dimensional model.

Here, in practice, the computer device may be installed with a client. The client may be a rendering client, or a client with a rendering function. The computer device can render the three-dimensional model through the client to obtain a corresponding two-dimensional image.

In some embodiments, the foregoing three-dimensional model is a model obtained by splicing a plurality of sub-models. Exemplarily, when the three-dimensional model is a virtual object model, sub-models corresponding to the three-dimensional model may include: a face model, a body model, a cloth model, and the like.

The triangle primitive refers to a minimum constituent unit of the three-dimensional model. In this embodiment of this application, before rendering the three-dimensional model, the computer device acquires the material information of the triangle primitives in the three-dimensional model. In this embodiment of this application, different sub-model may be made of different materials. Therefore, at least two triangle primitives have different material information.

In practice, the foregoing material information is acquired based on configuration parameters of the three-dimensional model. The configuration parameters are parameters configured during creation of the three-dimensional model.

In some embodiments, the foregoing configuration parameters are configured in units of sub-models. In practice, when acquiring material information of a triangle primitive, the computer device acquires configuration parameters of a sub-model based on the sub-model to which the triangle primitive belongs, and then acquire the material information of the triangle primitive from the configuration parameters.

In another possible implementation, the foregoing configuration parameters are configured in units of triangle primitives. For example, when acquiring material information of a triangle primitive, the computer device directly acquires the material information of the triangle primitive based on configuration parameters of the triangle primitive.

In some embodiments, the foregoing configuration parameters further include processing parameters. The processing parameters indicate a processing method for the three-dimensional model during rendering, such as configuration data of a shader used during rendering.

Step 302: Generate model parameters of the three-dimensional model based on the material information of the triangle primitives.

In this embodiment of this application, after acquiring the material information of the foregoing triangle primitives, the computer device generates the model parameters of the three-dimensional model based on the material information of the triangle primitives. The model parameters include rendering parameters of rasters in the three-dimensional model.

The foregoing raster refers to a minimum rendering area of the three-dimensional model. In practice, a triangle primitive includes a plurality of rasters. After acquiring the foregoing triangle primitives, the computer device determines the rasters included in the triangle primitives, and then generates the rendering parameters of the rasters in the triangle primitives based on the material information of the triangle primitives.

In practice, the rendering parameters of the foregoing raster include a first rendering parameter and a second rendering parameter. For the same triangle primitive, the first rendering parameter refers to a universal rendering parameter of the rasters, and the second rendering parameter refers to a non-universal rendering parameter of the rasters. Exemplarily, the foregoing first rendering parameter includes a material parameter, a processing parameter, and the like, and the foregoing second rendering parameter includes a color parameter, a texture parameter, a depth parameter, and the like. In some embodiments, the rendering parameters of the raster include a material parameter of the raster and another rendering parameter of the raster. The rasters in the three-dimensional model include vertex rasters and non-vertex rasters. When acquiring rendering parameters of a raster, the computer device determines a first rendering parameter of the raster based on configuration parameters of a triangle primitive, and determines a second rendering parameter of a non-vertex raster based on a position relationship between a vertex raster and the non-vertex raster in the triangle primitive, and a second rendering parameter of the vertex raster. In practice, the foregoing second rendering parameter may also be referred to as “another rendering parameter”.

Step 303: Render, based on rendering parameters of rasters, the three-dimensional model in basic units of rasters to obtain a two-dimensional image of the three-dimensional model.

In this embodiment of this application, after acquiring the foregoing model parameters, the computer device renders, based on the rendering parameters of the rasters, the three-dimensional model in basic units of rasters to generate the two-dimensional image of the three-dimensional model.

In some embodiments, step 303 includes at least one of the following steps.

1. The three-dimensional model is rendered in basic units of rasters based on the rendering parameters of the rasters to obtain an initial image of the three-dimensional model.

In this embodiment of this application, after acquiring the foregoing model parameters, the computer device renders, based on the rendering parameters of the rasters, the three-dimensional model in basic units of rasters to obtain rendering results of the rasters, and then combines the rendering results of the plurality of rasters into the initial image of the three-dimensional model.

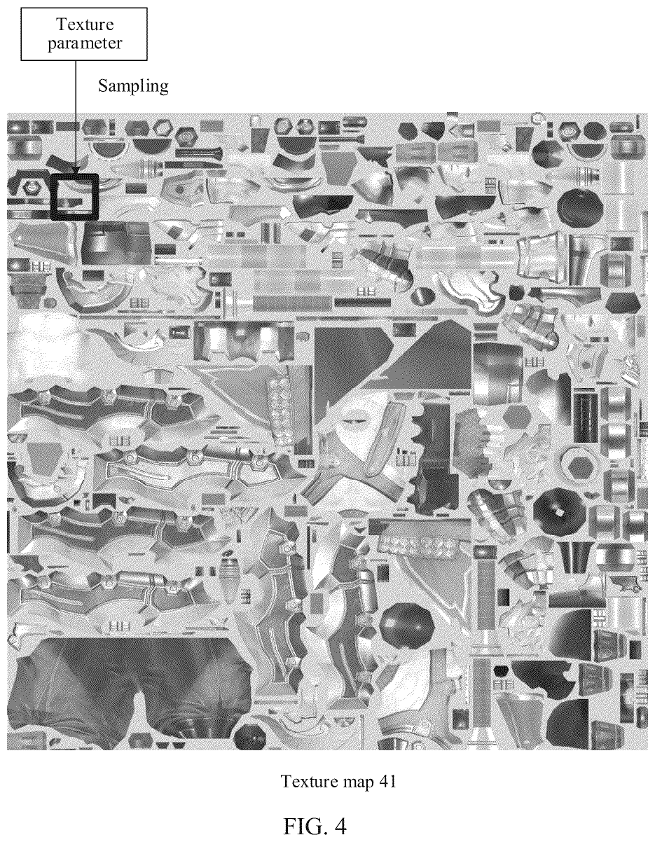

In some embodiments, the foregoing rendering parameters include, but are not limited to, at least one of a material parameter, a color parameter, a depth parameter, and a texture parameter. In practice, during rendering, material rendering is performed on a raster based on a material parameter in rendering parameters of the raster. Color rendering is performed on the raster based on a color parameter in the rendering parameters of the raster. Depth rendering is performed on the raster based on a depth parameter in the rendering parameters of the raster. Texture rendering is performed on the raster based on a texture parameter in the rendering parameters of the raster. Exemplarily, as shown in FIG. 4, during texture rendering, a texture map 41 is sampled based on the texture parameter to obtain a texture map corresponding to the raster for rendering.

In some embodiments, when rendered in basic units of rasters, the three-dimensional model may be rendered row by row or column by column according to a sequence of the rasters, or a central part is rendered first and then a peripheral part is rendered. This is not defined in this embodiment of this application.

2. The initial image of the three-dimensional model is corrected to obtain the two-dimensional image of the three-dimensional model.

In this embodiment of this application, after acquiring the foregoing initial image, in order to improve an image effect of the two-dimensional image, the computer device corrects the initial image to generate the two-dimensional image of the three-dimensional model. Exemplarily, a correction method for the initial image includes, but is not limited to, at least one of: tone mapping, gamma correction, anti-aliasing correction, and the like.

In conclusion, in the technical solutions provided in the embodiments of this application, the three-dimensional model is rendered based on the rendering parameters of the rasters, and the rendering parameters of the rasters are acquired based on the material information of the triangle primitives. That is, during rendering, the three-dimensional model is rendered in units of rasters based on the rendering parameters of the rasters. The rendering parameters of the rasters are generated based on different material information, that is, effects of the triangle primitives of different materials in the three-dimensional model on the rendering results are fused, so that the accuracy and effect of the two-dimensional image obtained by rendering are high. Furthermore, the material information is used as a partial basis for generating the rendering parameters, so that parts of different materials in the three-dimensional model can be rendered at one time, and the efficiency of rendering the three-dimensional model into the two-dimensional image is improved.

Next, an example in which the foregoing first rendering parameter includes a material parameter is used for describing a method for acquiring rendering parameters.

In some embodiments, step 302 includes at least one of the following steps.

Step 1: Perform rasterization on the three-dimensional model to obtain at least one raster in the three-dimensional model and a barycentric coordinate system of the triangle primitives in the three-dimensional model.

In this embodiment of this application, before acquiring the foregoing rendering parameters, the computer device performs rasterization on the three-dimensional model to obtain the at least one raster in the three-dimensional model and the barycentric coordinate system of the triangle primitives in the three-dimensional model.

In some embodiments, the computer device may perform rasterization on the three-dimensional model in the following way to obtain the at least one raster in the three-dimensional model: The computer device acquires first vertex data of the three-dimensional model. The first vertex data indicates vertex information of the three-dimensional model in a model coordinate system. The computer device performs first space conversion on the first vertex data to obtain second vertex data. The second vertex data indicates vertex information of the three-dimensional model in a world coordinate system. The computer device determines a contour image of the three-dimensional model in a screen space based on the second vertex data, and performs rasterization on the contour image to obtain the at least one raster in the three-dimensional model.

In practice, the computer device may determine the contour image of the three-dimensional model in the screen space based on the second vertex data in the following way: The computer device performs second space conversion on the second vertex data to obtain third vertex data, removes depth information from the third vertex data to obtain fourth vertex data, and determines the contour image of the three-dimensional model in the screen space based on the fourth vertex data. The third vertex data indicates vertex information of the three-dimensional model in a clip coordinate system, and the fourth vertex data indicates vertex information of the three-dimensional model in a screen coordinate system.

In this embodiment of this application, the foregoing three-dimensional model is composed of a plurality of sub-models. Therefore, when acquiring the foregoing first vertex data, the computer device acquires the plurality of sub-models of the three-dimensional model, and combines vertex data of the plurality of sub-models into the first vertex data of the three-dimensional model.

Combination of the plurality of sub-models into the three-dimensional model further includes combination of bone data and combination of skin data.

Step 2: Insert, based on a position of the raster and a position of a triangle primitive, material information into the raster to generate a material parameter of the raster.

In this embodiment of this application, after acquiring the foregoing raster, the computer device inserts, based on the position of the raster and the position of the triangle primitive, the material information into the raster to generate the material parameter of the raster.

In practice, when performing interpolation, the computer device determines the triangle primitive to which the raster belongs, and then inserts material information of the triangle primitive into the raster to generate the material parameter of the raster.

Step 3: Generate another rendering parameter of a non-vertex raster based on the barycentric coordinate system of the triangle primitive and another rendering parameter of a vertex raster of the triangle primitive.

In this embodiment of this application, after acquiring the foregoing barycentric coordinate system, the computer device generates the another rendering parameter of the non-vertex raster based on the barycentric coordinate system of the triangle primitive and the another rendering parameter of the vertex raster of the triangle primitive. The another rendering parameter is the foregoing second rendering parameter.

In some embodiments, the computer device acquires the another rendering parameter of the vertex raster of the triangle primitive, determines a variation function of the triangle primitive based on a position relationship of the vertex raster of the triangle primitive in the barycentric coordinate system, and generates, based on a position relationship between the non-vertex raster and the vertex raster, the another rendering parameter of the non-vertex raster by processing the another rendering parameter of the vertex raster by using the variation function. The foregoing variation function indicates variation rules of another rendering parameters of different rasters. In practice, the variation function is a linear variation function.

In this embodiment of this application, the rendering parameters of the foregoing raster include a material parameter of the raster and another rendering parameter of the raster. Exemplarily, the foregoing another rendering parameter includes, but is not limited to, at least one of: a color parameter, a depth parameter, and a texture parameter.

In conclusion, in the technical solutions provided in the embodiments of this application, the material parameter of the raster is generated by inserting the material information of the triangle primitive into the raster. During subsequent rendering, material rendering can be performed on the raster based on the material parameter. That is, during rendering of the three-dimensional model, rendering of the triangle primitives of different materials can be realized by raster rendering, which improves the rendering efficiency.

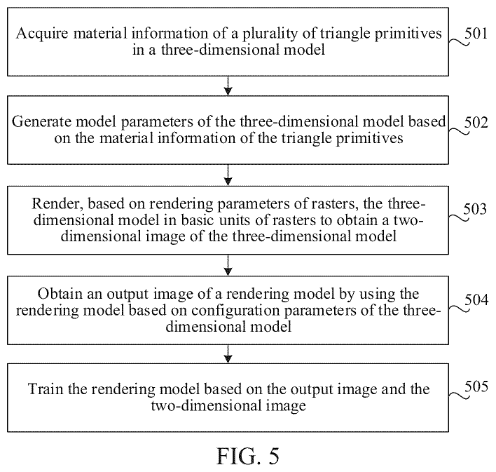

In some embodiments, the two-dimensional image of the foregoing three-dimensional model may be used for training of a rendering model. FIG. 5 is a flowchart of a three-dimensional model rendering method according to an embodiment of this application. The method may be applied to the server 20 and/or the terminal 10 (hereinafter collectively referred to as a “computer device”) in the model rendering system shown in FIG. 1. For example, an executive subject of the steps may be the server 20 and/or the client of the application program in the terminal 10. The method may include at least one of the following steps (501 to 505).

Step 501: Acquire material information of a plurality of triangle primitives in a three-dimensional model.

Step 502: Generate model parameters of the three-dimensional model based on the material information of the triangle primitives.

Step 503: Render, based on rendering parameters of rasters, the three-dimensional model in basic units of rasters to obtain a two-dimensional image of the three-dimensional model.

Step 501 to step 503 are the same as step 301 to step 303 in the embodiment in FIG. 3, may refer to the embodiment in FIG. 3, and will not be described in detail here.

Step 504: Obtain an output image of a rendering model by using the rendering model based on configuration parameters of the three-dimensional model.

In practice, after the configuration parameters, such as rendering parameters, of the three-dimensional model are acquired, the configuration parameters of the three-dimensional model may be inputted into a to-be-trained rendering model. A two-dimensional image corresponding to the three-dimensional model is predicted, based on the configuration parameters of the three-dimensional model, by using the rendering model to obtain the output image.

In this embodiment of this application, the output image of the rendering model is obtained by using the rendering model based on the configuration parameters of the three-dimensional model. The rendering model is a deep learning model.

In practice, the foregoing configuration parameters include property parameters and processing parameters of the three-dimensional model. The property parameters indicate properties of the three-dimensional model, such as material data, color data, depth data, texture data, and vertex data.

Step 505: Train the rendering model based on the output image and the two-dimensional image.

In this embodiment of this application, after acquiring the foregoing output image, the computer device takes the foregoing two-dimensional image as a label image, and trains the rendering model based on the output image and the two-dimensional image. That is, the computer device acquires a difference between the output image and the two-dimensional image, and updates model parameters of the rendering model based on the obtained difference.

In practice, during training of the rendering model, the computer device extracts first model data of the three-dimensional model from the output image, acquires second model data of the three-dimensional model from the two-dimensional image, determines a loss of the rendering model based on the first model data and the second model data, and adjusts the model parameters of the rendering model based on the loss.

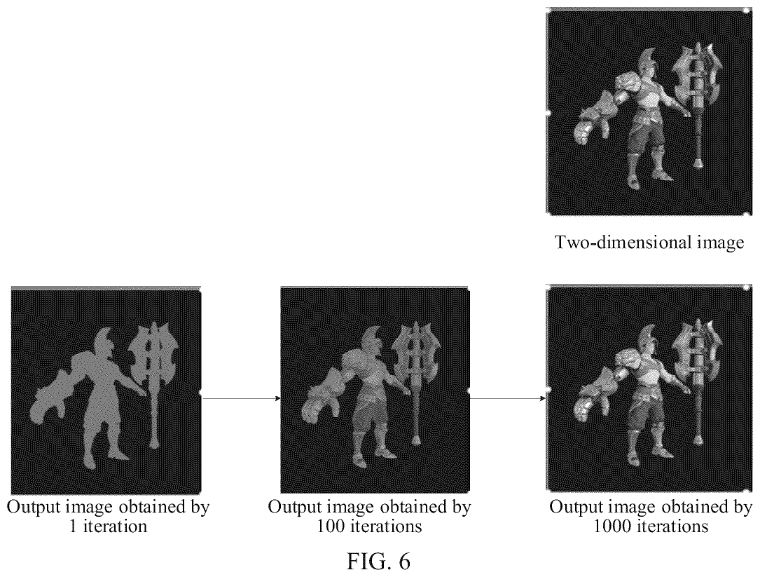

In addition, as shown in FIG. 6, during training of the rendering model, the rendering model is trained by multiple iterations of backpropagation.

In conclusion, in the technical solutions provided in the embodiments of this application, the rendering model is trained based on the two-dimensional image obtained by rendering the three-dimensional model and the configuration parameters of the three-dimensional model, so that the trained rendering model can perform rendering based on configuration parameters of a to-be-rendered three-dimensional model to obtain a two-dimensional image, to improve the image rendering efficiency.

The following describes apparatus embodiments of this application, which may be configured to implement the method embodiments of this application. For details undisclosed in the apparatus embodiments of this application, refer to the method embodiments of this application.

FIG. 7 is a block diagram of a three-dimensional model rendering apparatus according to an embodiment of this application. The apparatus has a function of implementing the foregoing three-dimensional model rendering method. The function may be implemented by hardware or may be implemented by hardware executing corresponding software. The apparatus may be a computer device or may be deployed in a computer device. The apparatus 700 may include:

a material acquiring module 710, configured to acquire material information of a plurality of triangle primitives in a three-dimensional model, at least two triangle primitives in the plurality of triangle primitives having different material information;

a parameter generating module 720, configured to generate model parameters of the three-dimensional model based on the material information of the triangle primitives, the model parameters including rendering parameters of rasters in the three-dimensional model; and

an image rendering module 730, configured to render, based on the rendering parameters of the rasters, the three-dimensional model in basic units of rasters to obtain a two-dimensional image of the three-dimensional model.

In some embodiments, the rendering parameters of the raster include a material parameter of the raster and another rendering parameter of the raster. The rasters in the three-dimensional model include vertex rasters and non-vertex rasters. The parameter generating module 720 is further configured to:
perform rasterization on the three-dimensional model to obtain at least one raster in the three-dimensional model and a barycentric coordinate system of the triangle primitives in the three-dimensional model,
insert, based on a position of the raster and a position of a triangle primitive, material information into the raster to generate a material parameter of the raster, and
generate another rendering parameter of a non-vertex raster based on the barycentric coordinate system of the triangle primitive and another rendering parameter of a vertex raster of the triangle primitive.

In some embodiments, the parameter generating module 720 is configured to:
determine a variation function of the triangle primitive based on a position relationship of the vertex raster of the triangle primitive in the barycentric coordinate system, the variation function indicating variation rules of another rendering parameters of different rasters, and
perform, based on a position relationship between the non-vertex raster and the vertex raster, parameter conversion on the another rendering parameter of the vertex raster by using the variation function to obtain the another rendering parameter of the non-vertex raster.

In some embodiments, the another rendering parameter includes at least one of: a color parameter, a depth parameter, and a texture parameter.

In some embodiments, the parameter generating module 720 is further configured to:
acquire first vertex data of the three-dimensional model, the first vertex data indicating vertex information of the three-dimensional model in a model coordinate system,
perform first space conversion on the first vertex data to obtain second vertex data, the second vertex data indicating vertex information of the three-dimensional model in a world coordinate system,
determine a contour image of the three-dimensional model in a screen space based on the second vertex data, and
perform rasterization on the contour image to obtain the at least one raster in the three-dimensional model.

In some embodiments, the parameter generating module 720 is further configured to:
perform second space conversion on the second vertex data to obtain third vertex data, the third vertex data indicating vertex information of the three-dimensional model in a clip coordinate system,
remove depth information from the third vertex data to obtain fourth vertex data, the fourth vertex data indicating vertex information of the three-dimensional model in a screen coordinate system, and
determine the contour image of the three-dimensional model in the screen space based on the fourth vertex data.

In some embodiments, the parameter generating module 720 is further configured to:
acquire a plurality of sub-models of the three-dimensional model, and
combine vertex data of the plurality of sub-models into the first vertex data of the three-dimensional model.

In some embodiments, the image rendering module 730 is configured to:
render, based on the rendering parameters of the rasters, the three-dimensional model in basic units of rasters to obtain an initial image of the three-dimensional model, and
correct the initial image of the three-dimensional model to obtain the two-dimensional image of the three-dimensional model.

In some embodiments, the image rendering module 730 is further configured to:
perform material rendering on a raster based on a material parameter in rendering parameters of the raster,
perform color rendering on the raster based on a color parameter in the rendering parameters of the raster,
perform depth rendering on the raster based on a depth parameter in the rendering parameters of the raster, and
perform texture rendering on the raster based on a texture parameter in the rendering parameters of the raster.

In some embodiments, the apparatus 700 is further configured to:
acquire configuration parameters of the three-dimensional model,
predict, based on the configuration parameters of the three-dimensional model, a two-dimensional image corresponding to the three-dimensional model by using a rendering model to obtain an output image, and
train, based on the output image and the two-dimensional image, the rendering model to obtain a trained rendering model,
the trained rendering model being configured to predict a two-dimensional image of a to-be-rendered three-dimensional model based on rendering parameters of the to-be-rendered three-dimensional model.

In some embodiments, the apparatus 700 is further configured to:
extract first model data of the three-dimensional model from the output image,
acquire second model data of the three-dimensional model from the two-dimensional image,
determine a loss of the rendering model based on the first model data and the second model data, and
adjust model parameters of the rendering model based on the loss.

In conclusion, in the technical solutions provided in the embodiments of this application, the three-dimensional model is rendered based on the rendering parameters of the rasters, and the rendering parameters of the rasters are acquired based on the material information of the triangle primitives. That is, during rendering, the three-dimensional model is rendered in units of rasters based on the rendering parameters of the rasters. The rendering parameters of the rasters are generated based on different material information, that is, effects of the triangle primitives of different materials in the three-dimensional model on the rendering results are fused, so that the accuracy and effect of the two-dimensional image obtained by rendering are high. Furthermore, the material information is used as a partial basis for generating the rendering parameters, so that parts of different materials in the three-dimensional model can be rendered at one time, and the efficiency of rendering the three-dimensional model into the two-dimensional image is improved.

When the apparatus according to the foregoing embodiments implements the functions of the apparatus, only division of the foregoing function modules is used as an example for description. In practice, the foregoing functions may be allocated to and completed by different function modules as needed. That is, an internal structure of a device is divided into different function modules, to complete all or some of the foregoing functions. In addition, the apparatus according to the foregoing embodiments and the method embodiments fall within the same conception. For details of an implementation of the apparatus, refer to the method embodiments. Details will not be described here.

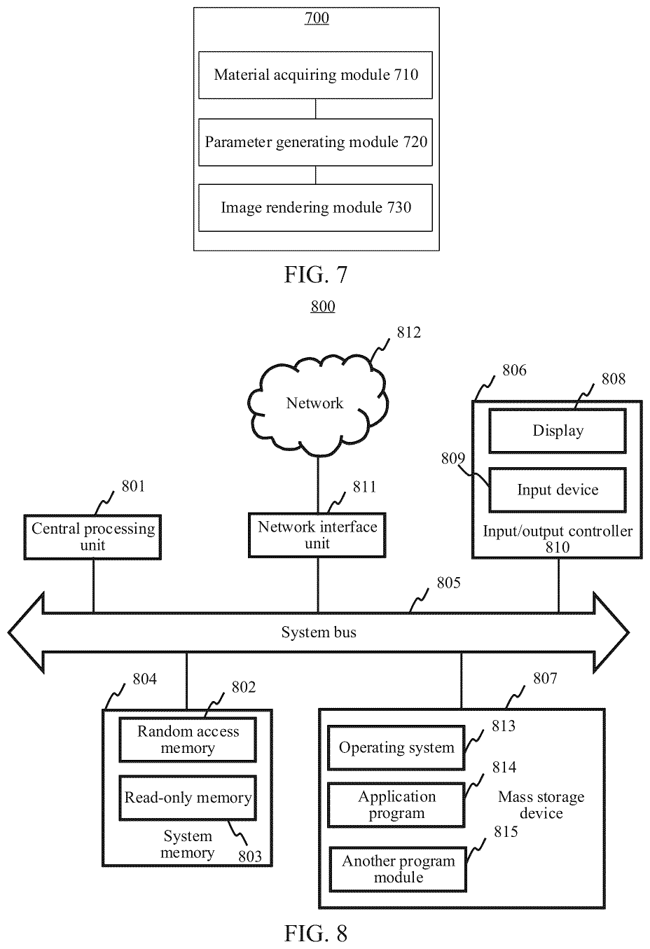

FIG. 8 is a structural block diagram of a computer device according to an embodiment of this application. The computer device may be configured to implement the foregoing three-dimensional model rendering method.

The computer device 800 includes a central processing unit (CPU) 801, a system memory 804 including a random access memory (RAM) 802 and a read-only memory (ROM) 803, and a system bus 805 connecting the system memory 804 to the CPU 801. The computer device 800 further includes a basic input/output (I/O) system 806 assisting in transmitting information between the components in the computer, and a mass storage device 807 configured to store an operating system 813, an application program 814, and another program module 815.

The basic I/O system 806 includes a display 808 configured to display information and an input device 809, such as a mouse or a keyboard, that is used by a user to input information. The display 808 and the input device 809 are both connected to the CPU 801 through an input/output controller 810 connected to the system bus 805. The basic I/O system 806 may further include the input/output controller 810 that is configured to receive and process inputs from a plurality of other devices such as a keyboard, a mouse, and an electronic stylus. Similarly, the input/output controller 810 further provides an output to a display screen, a printer or another type of output device.

The mass storage device 807 is connected to the CPU 801 through a mass storage controller (not shown) connected to the system bus 805. The mass storage device 807 and a computer-readable medium associated with the mass storage device provide non-volatile storage for the computer device 800. That is, the mass storage device 807 may include a computer-readable medium (not shown) such as a hard disk or a compact disc ROM (CD-ROM) drive.

Generally, the computer-readable medium may include a computer storage medium and a communication medium. The computer storage medium includes volatile and non-volatile media, and removable and non-removable media implemented by any method or technology for storing information such as computer-readable instructions, data structures, program modules or other data. The computer storage medium includes an ROM, an RAM, an erasable programmable ROM (EPROM), an electrically erasable programmable ROM (EEPROM), a flash memory or another solid-state storage device, a CD-ROM, a high-density digital video disc (DVD) or another optical memory, a tape cartridge, a magnetic cassette, a magnetic disk memory or another magnetic storage device. Certainly, those skilled in the art may know that the computer storage medium is not limited to the foregoing several types. The foregoing system memory 804 and the mass storage device 807 may be collectively referred to as a memory.

According to the embodiments of this application, the computer device 800 may further be connected, through a network such as the Internet, to a remote computer on the network and run. That is, the computer device 800 may be connected to a network 812 through a network interface unit 811 connected to the system bus 805, or may be connected to another type of network or a remote computer system (not shown) through the network interface unit 811.

The memory further includes a computer program. The computer program is stored in the memory and executed by one or more processors to implement the foregoing three-dimensional model rendering method.

In some embodiments, a computer-readable storage medium is further provided. The storage medium stores at least one instruction, at least one program, a code set or an instruction set that, when executed by a processor, implements the foregoing three-dimensional model rendering method.

In practice, the computer-readable storage medium may include: an ROM, an RAM, a solid state drive (SSD), an optical disc or the like. The RAM may include a resistance RAM (ReRAM) and a dynamic RAM (DRAM).

In some embodiments, a computer program product or computer program is further provided. The computer program product or computer program includes computer instructions. The computer instructions are stored in a computer-readable storage medium. A processor of a computer device reads the computer instructions from the computer-readable storage medium and executes the computer instructions, and the computer device is enabled to perform the foregoing three-dimensional model rendering method.

The term “a plurality of” mentioned herein means two or more. The term “and/or” describes an association relationship between associated objects and represents that three relationships may exist. For example, A and/or B may represent the following cases: Only A exists, both A and B exist, and only B exists. The character “/” generally indicates an “or” relationship between associated objects. In addition, the step numbers described herein merely exemplarily show a possible execution sequence of the steps. In some other embodiments, the steps may not be performed according to the number sequence. For example, two steps with different numbers may be performed simultaneously, or two steps with different numbers may be performed according to a sequence contrary to the sequence shown in the figure. This is not defined in the embodiments of this application.

In this application, the term “module” or “unit” in this application refers to a computer program or part of the computer program that has a predefined function and works together with other related parts to achieve a predefined goal and may be all or partially implemented by using software, hardware (e.g., processing circuitry and/or memory configured to perform the predefined functions), or a combination thereof. Each module or unit can be implemented using one or more processors (or processors and memory). Likewise, a processor (or processors and memory) can be used to implement one or more modules or units. Moreover, each module or unit can be part of an overall module or unit that includes the functionalities of the module or unit. The foregoing descriptions are merely exemplary embodiments of this application, but are not intended to limit this application. Any modification, equivalent replacement, improvement or the like made without departing from the spirit and principle of this application shall fall within the scope of protection of this application.

What is claimed is:

1. A three-dimensional model rendering method performed by a computer device and the method comprising:
acquiring material information of a plurality of triangle primitives in a three-dimensional model, at least two triangle primitives in the plurality of triangle primitives having different material information;
generating model parameters of the three-dimensional model based on the material information of the triangle primitives, the model parameters comprising rendering parameters of rasters in the three-dimensional model; and
rendering a two-dimensional image of the three-dimensional model based on the rendering parameters of the rasters.

2. The method according to claim 1, wherein the rendering parameters of a raster comprise a material parameter of the raster and another rendering parameter of the raster, the rasters in the three-dimensional model comprise vertex rasters and non-vertex rasters; and the generating model parameters of the three-dimensional model based on the material information of the triangle primitives comprises:
performing rasterization on the three-dimensional model to obtain at least one raster in the three-dimensional model and a barycentric coordinate system of a triangle primitive in the three-dimensional model;
inserting, based on a position of the raster and a position of the triangle primitive, material information into the raster to generate a material parameter of the raster, and
generating another rendering parameter of a non-vertex raster based on the barycentric coordinate system of the triangle primitive and the another rendering parameter of a vertex raster of the triangle primitive.

3. The method according to claim 2, wherein the generating another rendering parameter of a non-vertex raster based on the barycentric coordinate system of the triangle primitive and the another rendering parameter of a vertex raster of the triangle primitive comprises:
determining a variation function of the triangle primitive based on a position relationship of the vertex raster of the triangle primitive in the barycentric coordinate system, the variation function indicating variation rules of the another rendering parameter of different rasters; and
performing, based on a position relationship between the non-vertex raster and the vertex raster, parameter conversion on the another rendering parameter of the vertex raster by using the variation function to obtain the another rendering parameter of the non-vertex raster.

4. The method according to claim 2, wherein the another rendering parameter comprises at least one of: a color parameter, a depth parameter, and a texture parameter.

5. The method according to claim 2, wherein the performing rasterization on the three-dimensional model to obtain at least one raster in the three-dimensional model comprises:
acquiring first vertex data of the three-dimensional model, the first vertex data indicating vertex information of the three-dimensional model in a model coordinate system;
performing first space conversion on the first vertex data to obtain second vertex data, the second vertex data indicating vertex information of the three-dimensional model in a world coordinate system;
determining a contour image of the three-dimensional model in a screen space based on the second vertex data; and
performing rasterization on the contour image to obtain the at least one raster in the three-dimensional model.

6. The method according to claim 5, wherein the determining a contour image of the three-dimensional model in a screen space based on the second vertex data comprises:
performing second space conversion on the second vertex data to obtain third vertex data, the third vertex data indicating vertex information of the three-dimensional model in a clip coordinate system;
removing depth information from the third vertex data to obtain fourth vertex data, the fourth vertex data indicating vertex information of the three-dimensional model in a screen coordinate system; and
determining the contour image of the three-dimensional model in the screen space based on the fourth vertex data.

7. The method according to claim 5, wherein the acquiring first vertex data of the three-dimensional model comprises:
acquiring a plurality of sub-models of the three-dimensional model; and
combining vertex data of the plurality of sub-models into the first vertex data of the three-dimensional model.

8. The method according to claim 1, wherein the rendering a two-dimensional image of the three-dimensional model based on the rendering parameters of the rasters comprises:
rendering an initial image of the three-dimensional model based on the rendering parameters of the rasters; and
updating the initial image of the three-dimensional model to obtain the two-dimensional image of the three-dimensional model.

9. The method according to claim 8, wherein the rendering an initial image of the three-dimensional model based on the rendering parameters of the rasters comprises:
performing material rendering on a raster based on a material parameter in rendering parameters of the raster;
performing color rendering on the raster based on a color parameter in the rendering parameters of the raster;
performing depth rendering on the raster based on a depth parameter in the rendering parameters of the raster; and
performing texture rendering on the raster based on a texture parameter in the rendering parameters of the raster.

10. A computer device, comprising a processor and a memory, the memory storing at least one instruction that, when loaded and executed by the processor, causes the computer device to implement a three-dimensional model rendering method including:
acquiring material information of a plurality of triangle primitives in a three-dimensional model, at least two triangle primitives in the plurality of triangle primitives having different material information;
generating model parameters of the three-dimensional model based on the material information of the triangle primitives, the model parameters comprising rendering parameters of rasters in the three-dimensional model; and
rendering a two-dimensional image of the three-dimensional model based on the rendering parameters of the rasters.

11. The computer device according to claim 10, wherein the rendering parameters of a raster comprise a material parameter of the raster and another rendering parameter of the raster, the rasters in the three-dimensional model comprise vertex rasters and non-vertex rasters; and the generating model parameters of the three-dimensional model based on the material information of the triangle primitives comprises:
performing rasterization on the three-dimensional model to obtain at least one raster in the three-dimensional model and a barycentric coordinate system of a triangle primitive in the three-dimensional model;
inserting, based on a position of the raster and a position of the triangle primitive, material information into the raster to generate a material parameter of the raster, and
generating another rendering parameter of a non-vertex raster based on the barycentric coordinate system of the triangle primitive and the another rendering parameter of a vertex raster of the triangle primitive.

12. The computer device according to claim 11, wherein the generating another rendering parameter of a non-vertex raster based on the barycentric coordinate system of the triangle primitive and the another rendering parameter of a vertex raster of the triangle primitive comprises:
determining a variation function of the triangle primitive based on a position relationship of the vertex raster of the triangle primitive in the barycentric coordinate system, the variation function indicating variation rules of the another rendering parameter of different rasters; and
performing, based on a position relationship between the non-vertex raster and the vertex raster, parameter conversion on the another rendering parameter of the vertex raster by using the variation function to obtain the another rendering parameter of the non-vertex raster.

13. The computer device according to claim 11, wherein the another rendering parameter comprises at least one of a color parameter, a depth parameter, and a texture parameter.

14. The computer device according to claim 11, wherein the performing rasterization on the three-dimensional model to obtain at least one raster in the three-dimensional model comprises:
acquiring first vertex data of the three-dimensional model, the first vertex data indicating vertex information of the three-dimensional model in a model coordinate system;
performing first space conversion on the first vertex data to obtain second vertex data, the second vertex data indicating vertex information of the three-dimensional model in a world coordinate system;
determining a contour image of the three-dimensional model in a screen space based on the second vertex data; and
performing rasterization on the contour image to obtain the at least one raster in the three-dimensional model.

15. The computer device according to claim 14, wherein the determining a contour image of the three-dimensional model in a screen space based on the second vertex data comprises:
performing second space conversion on the second vertex data to obtain third vertex data, the third vertex data indicating vertex information of the three-dimensional model in a clip coordinate system;
removing depth information from the third vertex data to obtain fourth vertex data, the fourth vertex data indicating vertex information of the three-dimensional model in a screen coordinate system; and
determining the contour image of the three-dimensional model in the screen space based on the fourth vertex data.

16. The computer device according to claim 14, wherein the acquiring first vertex data of the three-dimensional model comprises:
acquiring a plurality of sub-models of the three-dimensional model; and
combining vertex data of the plurality of sub-models into the first vertex data of the three-dimensional model.

17. The computer device according to claim 10, wherein the rendering a two-dimensional image of the three-dimensional model based on the rendering parameters of the rasters comprises:
rendering an initial image of the three-dimensional model based on the rendering parameters of the rasters; and
updating the initial image of the three-dimensional model to obtain the two-dimensional image of the three-dimensional model.

18. The computer device according to claim 17, wherein the rendering an initial image of the three-dimensional model based on the rendering parameters of the rasters comprises:
performing material rendering on a raster based on a material parameter in rendering parameters of the raster;
performing color rendering on the raster based on a color parameter in the rendering parameters of the raster;
performing depth rendering on the raster based on a depth parameter in the rendering parameters of the raster; and
performing texture rendering on the raster based on a texture parameter in the rendering parameters of the raster.

19. A non-transitory computer-readable storage medium, storing at least one instruction that, when loaded and executed by a processor of a computer device, causes the computer device to implement a three-dimensional model rendering method including:
acquiring material information of a plurality of triangle primitives in a three-dimensional model, at least two triangle primitives in the plurality of triangle primitives having different material information;
generating model parameters of the three-dimensional model based on the material information of the triangle primitives, the model parameters comprising rendering parameters of rasters in the three-dimensional model; and
rendering a two-dimensional image of the three-dimensional model based on the rendering parameters of the rasters.

20. The non-transitory computer-readable storage medium according to claim 19, wherein the rendering a two-dimensional image of the three-dimensional model based on the rendering parameters of the rasters comprises:
rendering an initial image of the three-dimensional model based on the rendering parameters of the rasters; and
updating the initial image of the three-dimensional model to obtain the two-dimensional image of the three-dimensional model.
